(19) United States
(12) Patent Application Publication
(10) Pub. No.: US 2026/0315958 A1
(43) Pub. Date: Oct. 15, 2026

(54) Systems And Associated Methods for Ion Chromatography

(71) Applicant: Dionex Corporation, Sunnyvale, CA (US)

(72) Inventor: Yan Liu, Palo Alto, CA (US)

(21) Appl. No.: 19/643,898

(22) Filed: Apr. 10, 2026

Related U.S. Application Data
(60) Provisional application No. 63/787,289, filed on Apr. 11, 2025.

(51) Int. Cl. B01D 15/36; B01D 15/10

(52) U.S. Cl. CPC B01D 15/361; B01D 15/102; B01D 2311/2623; B01D 2313/18; B01D 2313/60; B01D 2325/42

(57) ABSTRACT

Systems and associated methods are described herein for ion chromatography. In one aspect of the present disclosure, an ion chromatography system can include: a sample injector; a multi-state valve in fluidic communication with the sample injector, the multi-state valve being transitionable between a first state and a second state; and a first detector in fluidic communication with the multi-state valve, where: a) the first state of the multi-state valve places the sample injector and a second detector in fluidic communication with the first detector, and b) the second state of the multi-state valve places the sample injector and the second detector in fluidic communication with a separation column.

### CROSS-REFERENCE TO RELATED APPLICATIONS

This application claims benefit to United States Provisional Application No. 63/787,289, filed Apr. 11, 2025, the entirety of which is incorporated by reference herein for any and all purposes.

### TECHNICAL FIELD

The present disclosure relates to the field of ion chromatography, and in particular systems and associated methods for calibrating an ion chromatography system.

### BACKGROUND

Ion chromatography systems can include a sample injector configured to pass a sample, eluent, or both, through a separation column and to a detector for measurements. However, the calibration of various system components typically occurs manually or not at all. For example, an ion chromatography system can typically include an electrolytic eluent generator, an electrolytic suppressor, and a conductivity detector disposed at the end of the flow path for the system. These components typically are not calibrated, or are calibrated manually. This manual calibration process can be time consuming and can be subject to human error. These and other issues are addressed within the present disclosure.

Systems and associated methods for ion chromatography are described herein. An ion chromatography system can include a multi-state valve that can transition between fluidically coupling a sample injector to a separation column of the system, and the sample injector with a first detector. Eluent, or a sample, from the sample injector can be passed to the first detector for a calibration procedure. The first detector can measure the eluent or sample, and the system can determine whether the eluent or sample includes proper characteristics such as concentration levels. In cases where the eluent or sample includes abnormal characteristics, the system can determine an abnormal condition that exists within the chromatography system, such as a condition associated with the eluent generator, the suppressor, or the second detector.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 shows an exemplary, non-limiting chromatography system according to the present disclosure.

FIG. 2 shows a subsystem of a chromatography system according to the present disclosure.

FIG. 3. shows a subsystem of a chromatography system according to the present disclosure.

FIG. 4 shows a process flow according to the present disclosure.

FIG. 5 shows a controller according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term "comprising" can include the embodiments "consisting of" and "consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as "consisting of" and "consisting essentially of" the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures, and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

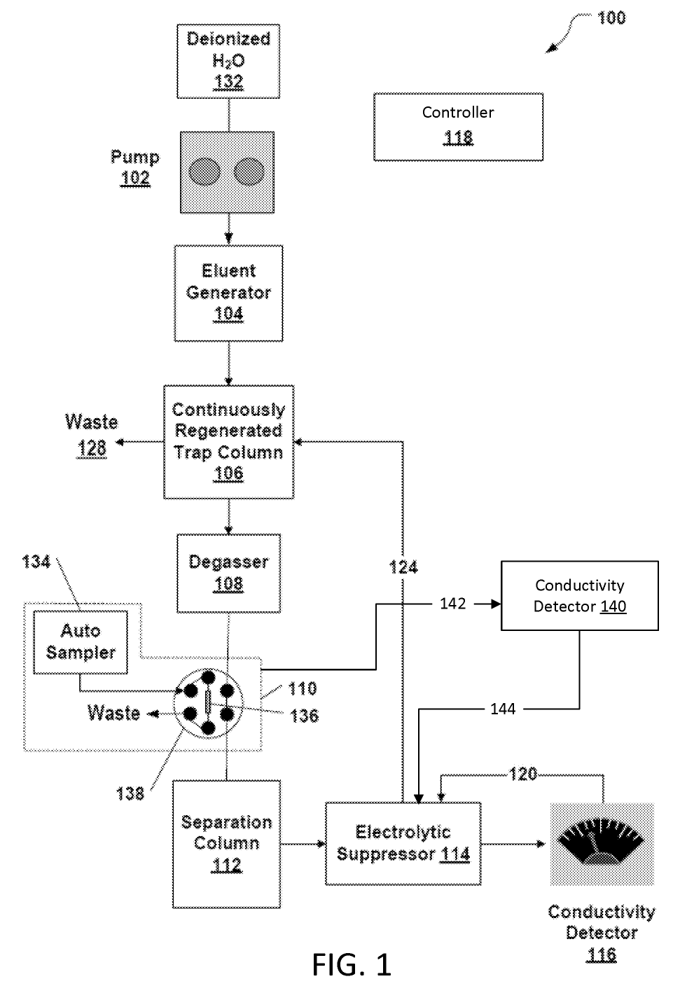

FIG. 1 illustrates an embodiment of a chromatography system 100 according to the present disclosure. The chromatography system 100 in some cases can be an ion chromatography system, and can include a pump 102, an electrolytic eluent generator 104, a continuously regenerated trap column 106, a degasser 108, a sample injector 110, a chromatographic separation device 112, an electrolytic suppressor 114, a detector 116, a controller 118, and a conductivity detector. Chromatographic separation device 112 can be in the form of a capillary column or an analytical column. Line 120 can be used to transfer the liquid from an output of detector 116 to an inlet of the electrolytic suppressor 114. Line 124 can be used to transfer liquid from an outlet of the regenerant channel of the electrolytic suppressor 114 to an inlet of the continuously regenerated trap column 106. Recycle line 128 can be used to transfer liquid from an outlet of the continuously regenerated trap column 106 to waste 128.

Pump 102 can be configured to pump a liquid from a liquid source 132, such as deionized water, and be fluidically connected to electrolytic eluent generator 104. Pump 102 can be configured to transport the liquid at a pressure ranging from, as a non-limiting example, about 20 PSI to about 15,000 PSI. Under certain circumstances, pressures greater than 15,000 PSI can be implemented. It should be noted that the pressures denoted herein are listed relative to an ambient pressure (13.7 PSI to 15.2 PSI, as non-limiting examples). Pump 102 can be in the form of a high-pressure liquid chromatography (HPLC) pump. In addition, pump 102 can also be configured so that the liquid only touches an inert portion of pump 102 so that a significant amount of impurities does not leach out. In this context, significant means an amount of impurities that would interfere with the intended measurement. For example, the inert portion can be made of, for example, polyether ether ketone (PEEK) or at least coated with a PEEK lining, which does not leach out a significant amount of ions when exposed to a liquid.

An eluent is a liquid that contains an acid, base, salt, , or mixture thereof and can be used to elute an analyte through a chromatography column. In addition, an eluent can include a mixture of a liquid and a water miscible organic solvent, where the liquid can include an acid, base, salt, or combination thereof. Electrolytic eluent generator 104 is configured to generate a generant. A generant refers to a particular species of acid, base, or salt that can be added to the eluent. In an embodiment, the generant can be a base such as cation hydroxide or the generant can be an acid such as carbonic acid, phosphoric acid, acetic acid, methanesulfonic acid, or a combination thereof.

Referring to FIG. 1, eluent generator 104 can be configured to receive the liquid from pump 102 and then add a generant to the liquid. The liquid containing the generant can be outputted from eluent generator 104 to an inlet of continuously regenerated trap column 106.

Continuously regenerated trap column 106 is configured to remove cationic or anionic contaminants from the eluent. Continuously regenerated trap column 106 can include an ion exchange bed with an electrode at the eluent outlet. An ion exchange membrane stack can separate the eluent from a second electrode and contaminate ions can be swept through the ion exchange membrane stack towards the second electrode. The ion exchange membrane stack can include one or more ion exchange membranes. . In another embodiment, the electrode can be placed near the outlet of the trap column and separated from the trap column with the ion exchange membrane stack. In various embodiments, anion removal can utilize an anion exchange bed with a cathode at the eluent outlet separated from an anode by an anion exchange membrane. Alternatively, cation removal can utilize a cation exchange bed with an anode at the eluent outlet separated from a cathode by a cation exchange membrane.

Degasser 108 can be used to remove residual gas. In an embodiment, a residual gas can be electrolytically generated such as hydrogen or oxygen. Degasser 108 can include a tubing section that is gas permeable and liquid impermeable such as, for example, amorphous fluoropolymers, including Teflon AF™. The flowing liquid can be outputted from degasser 108 to sample injector 110 with a substantial portion of the gas removed.

Sample injector 110 can be used to inject a bolus of a liquid sample into an eluent stream. The liquid sample can include a plurality of chemical constituents (i.e., matrix components) and one or more analytes of interest. The sample injector 110 can include an auto sampler 134, sample loop 136, and a multiport valve 138. The auto sampler 134 can draw a sample from a sample container. The multiport valve 138 can be in a first position to allow the sample to fill the sample loop 136. After the sample loop 136 is filled to the desired level, the multiport valve can switch to a second position and the eluent stream can drive the sample onto the chromatographic separation device 112.

Chromatographic separation device 112 can be used to separate various matrix components present in the liquid sample from the analyte(s) of interest. Typically, chromatographic separation device 112 can be in the form of a hollow cylinder that contains a packed stationary phase. As the liquid sample flows through chromatographic separation device 112, the matrix components and target analytes can have a range of retention times for eluting off of chromatographic separation device 112. Depending on the characteristics of the target analytes and matrix components, they can have different affinities to the stationary phase in chromatographic separation device 112. An output of chromatographic separation device 112 can be fluidically connected to electrolytic suppressor 114.

Suppressor 114 can be used to reduce eluent conductivity background and enhance analyte response through efficient exchange of eluent counterions for regenerant ions. One type of suppressor is an electrolytic suppressor 114 can include an anode chamber, a cathode chamber, and an eluent suppression bed chamber separated by ion exchange membranes. The anode chamber and/or cathode chamber can produce regenerate ions or transport supplied regenerant ions. The eluent suppression bed chamber can include a flow path for the eluent separated from the regenerant by an ion exchange barrier and eluent counterions can be exchanged with regenerate ions across the ion exchange barrier. An output of electrolytic suppressor 114 can be fluidically connected to detector 116 to measure the presence of the separated chemical constituents of the liquid sample. The suppressor 114 can also be of the chemical kind that requires a chemical regenerant for operation. One skilled in the art will understand that various other types of suppressors can be implemented in the system 100 of the present application. In another embodiment of the present invention, electrolytic suppressor is omitted. The effluent from the chromatographic separation device is directed directly to the inlet of detector 116.

Detector 116 can be in the form of an ultraviolet-visible spectrometer, a fluorescence spectrometer, a refractive index detector, a radio flow detector, a chiral detector, an electrochemical detector, a conductivity detector, a mass spectrometer, or a combination thereof. The detector 116 is preferably a non-destructive detector such as a conductivity detector that substantially preserves the eluent stream from the suppressor eluent output.

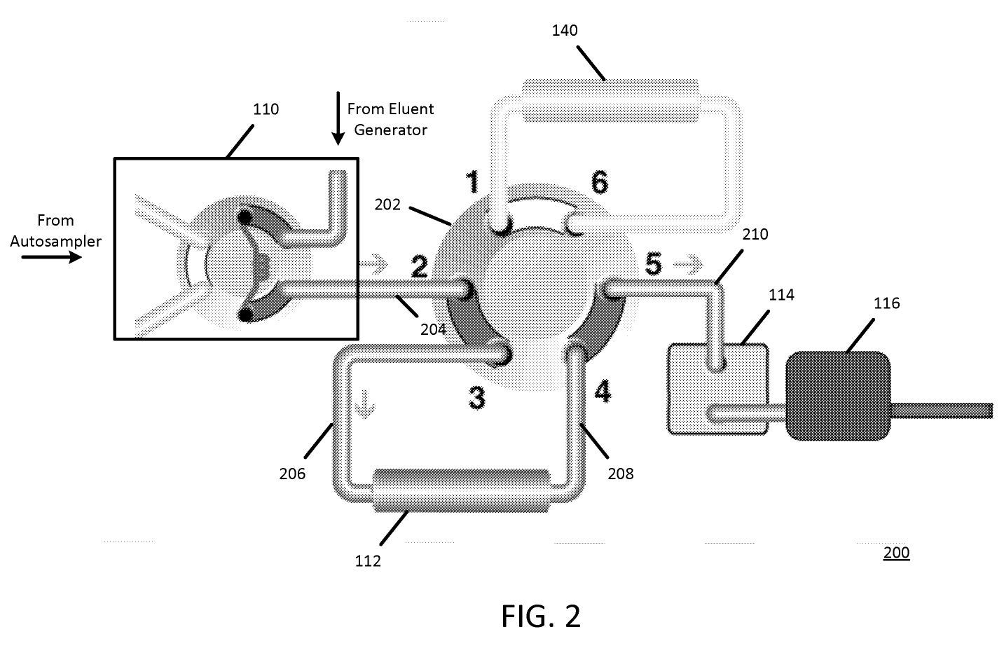

The chromatography system can include another detector 140. This detector 140 can be a conductivity detector, such as a high-pressure conductivity detector. In some cases, both the detector 140 and detector 116 are conductivity detectors, and can be referred to as a first and second conductivity detector. The detector 140 can be in fluidic communication with the sample injector 110 (e.g., via line 142). A multi-state valve (e.g., shown in FIG. 2), can facilitate the fluidic communication between the sample injector 110 and the detector 140. For example, the sample injector 110 can be in direct fluidic communication with the multi-state valve, and the multi-state valve can be in direct fluidic communication with the detector 140. Further, the detector 140 can be in fluidic communication the suppressor 114 (e.g., via line 144). Thus, the detector 140 can be in fluidic communication with the detector 116 via the suppressor 114. In some cases, the detector 140 can be in fluidic communication detector 116 without passing through the suppressor, for example the line 144 fluidically couples the detector 140 to the detector 116 as opposed to the suppressor 114.

As discussed in more detail below, the multi-state valve can be configured to fluidically couple and decouple the sample injector 110 to the detector 140. For example, the sample injector 110 can also be in fluidic communication with the separation column 112 via the multi-state valve. The multi-state valve, when in one state, can fluidically couple the sample injector 110 to the conductivity detector 140, and can fluidically decouple the sample injector 110 from the separation column 112. In another state, the multi-state valve can fluidically couple the sample injector 110 to the separation column 112, and can fluidically decouple the sample injector 110 to the detector 140.

An electronic circuit can include controller 118, a timer, and a memory portion. In addition, the electronic circuit can include a power supply that are configured to apply a controlling signal, respectively. Controller 118 can be used to control the operation of chromatography system 100. Controller 118 can either be integrated into chromatography system 100 or be part of a personal computer that communicates with chromatography system 100. Controller 118 can be configured to communicate with and control one or more components of chromatography system such as pump 102, eluent generator 104, sample injector 110, detector 116, detector 140, and the multi-state valve. The memory portion can be used to store instructions to set the magnitude and timing of the current waveform with respect to the switching of sample injector 110 that injects the sample.

FIG. 2 shows a subsystem 200 of a chromatography according to the present disclosure. The subsystem 200 can be a part of chromatography system 100 as discussed with reference to FIG. 1. The subsystem can include a sample injector 110, a separation device 112, a detector 140, a suppressor 114, a detector 116, and a multi-state valve 202.

The multi-state valve 202 can be in fluidic communication with the sample injector 110. For example, the multi-state valve 202 can be fluidically coupled to the sample injector, via a line 204, and received by a second port of the multi-state valve 202. The multi-state valve 202 can be configured to receive a fluid from the sample injector 110, such as a sample, an eluent, or both. Thus, the fluidic coupling between the sample injector 110 and the multi-state valve 202 can be considered a fluid input, and the second port of the multi-state valve 202 as an input valve.

FIG. 2 further shows the subsystem 200 when the multi-state valve 202 is in a first state. In the first state, the multi-state valve 202 can fluidically couple the input valve to another port, such as a third port of the multi-state valve 202. The third port can be fluidically coupled to the separation device 112 (e.g., via line 206). The separation device 112 can be fluidically coupled to a fourth port of the multi-state valve 202 (e.g., via line 208). The fourth port of the multi-state valve 202 can be fluidically coupled to the fifth port, which in turn can be coupled to a fifth port of the multi-state valve 202. The fifth port of the multi-state valve 202 can be fluidically coupled to the suppressor 114 (via line 210). The suppressor can be fluidically coupled to the detector 116. Thus, when the multi-state valve 202 is in the first state, the sample injector 110 can be in fluidic communication, via the multi-state valve 202, with the separation device 112, the suppressor 114, and the detector 116. Further, the subsystem 200 may be configured to transfer fluid, from the sample injector 110, to the separation device 112, the suppressor 114, and the detector 116 when the multi-state valve 202 is in the first state.

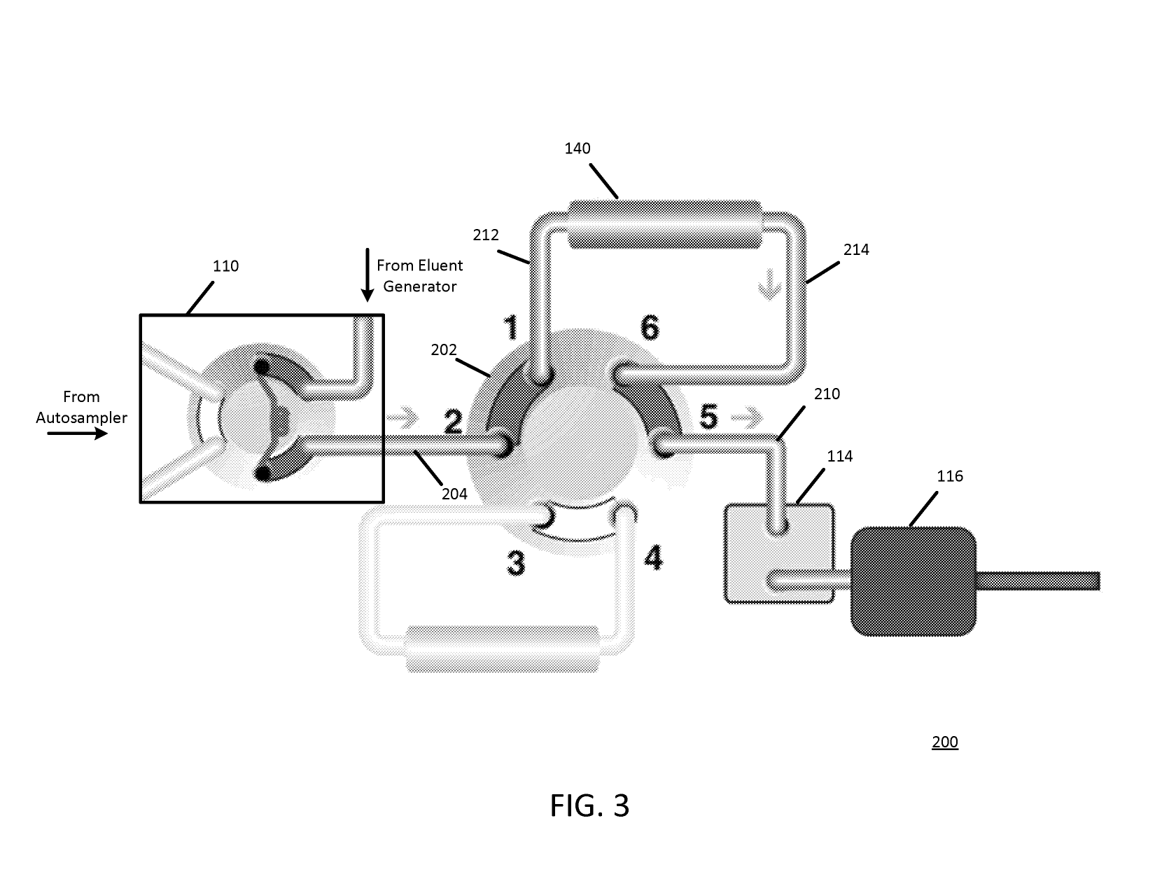

FIG. 3 further shows the subsystem 200 when the multi-state valve 202 is in a second state. In the second state, the multi-state valve 202 can fluidically couple the input valve to another port, such as a first port of the multi-state valve 202. The first port can be fluidically coupled to the detector 140 (e.g., via line 212). The detector 140 can be fluidically coupled to a sixth port of the multi-state valve 202 (e.g., via line 214). The sixth port of the multi-state valve 202 can be fluidically coupled to the fifth port. The fifth port of the multi-state valve 202 can be fluidically coupled to the suppressor 114 (via line 210). The suppressor can be fluidically coupled to the detector 116. Thus, when the multi-state valve 202 is in the second state, the sample injector 110 can be in fluidic communication, via the multi-state valve 202, with the detector 140, the suppressor 114, and the detector 116. Further, the subsystem 200 can be configured to transfer fluid, from the sample injector 110, to the detector 140, the suppressor 114, and the detector 116 when the multi-state valve 202 is in the second state.

According to the present disclosure, the chromatography system described herein can facilitate calibration or troubleshooting procedures unavailable to conventional chromatography systems. For example, the system can cause the sample injector 110 to transfer fluid (e.g., a sample, an eluent, or both) to the multi-state valve 202 while in the second state. The fluid can pass to the detector 140, which can measure one or more characteristics of the fluid. The system can be able to determine whether any issues exist with the fluid based on the measurements. For example, the measurements can indicate whether the fluid comprises a sufficient sample concentration, which can be possible since the fluid does not pass through the separation device 112, suppressor 114, or detector 116 prior to the detector 140 measuring the fluid. In some cases, the measurements can be indicative of an issue associated with the eluent generator or autosampler further upstream. For example, the measurements of the fluid can indicate a flow rate issue corresponding to the origin of the fluid. If the fluid is eluent, the measurements can indicate an issue with the eluent generator. If the fluid is a sample, the measurements can indicate an issue with autosampler.

In another example, the fluid can pass through the multi-state valve 202 in the second state. The detector 140 can measure one or more characteristics of the fluid. The fluid can also pass to the detector 114, which can also measure one or more characteristics of the fluid. The system can use the results of the measurements of the detectors 140 and 116 to determine whether any issues associated with the chromatography system. In some cases, the results of measurements can be indicative of an issue associated with pump 102, eluent generator 104, autosampler 134, the detector 140, the detector 116, or the suppressor 114, which can be typically undetectable in conventional chromatography systems. Several examples are described herein.

In one example, the multi-state valve 202 is in the second state. The response of detector 140 can be used to determine if the concentration of eluent generated by electrolytic eluent generator is accurate. If the response is lower than expected, possible issues may include that the pump 102 delivers deionized water at higher than the set flow rate or the electrical current applied to the eluent generator is too low. If the response is higher than expected, possible issues may include that the pump 102 delivers deionized water at lower than the set flow rate or the electrical current applied to the eluent generator is too high. In another example, the eluent generated by the eluent generator is a potassium hydroxide eluent. As the eluent flow into suppressor 114, the conductance of the eluent is reduced to a level that is similar to that of deionized water. If detector 116 does not provide the expected response, the suppressor may not function properly. Additional diagnostics of the suppressor is required.

In another example, the multi-state valve 202 is in the first state. The autosampler of the system is programmable to inject a standard solution of containing the target analyte. Detector 116 provides the response for the targeted analyte. If the response matches the expected value. The operation of the entire ion chromatography system operation is validated. If the response does not match the expected value, additional diagnostics of the various system components is required.

There are other examples in which those who skill in the art of ion chromatography can use the two detectors in the system of the present invention alone or in combination to validate if various components of the ion chromatography operates to the specifications.

The systems described herein can facilitate calibration and diagnosis procedures typically unavailable to conventional chromatography systems. The processes described above can be performed on an iterative basis, and thus can be used as a calibration mechanism prior to implementing the system for chromatography measurements (e.g., when the multi-state valve 202 is in the first state). In other cases, the processes described above can be used for troubleshooting the system, such as due to the result of inaccurate chromatography measurements.

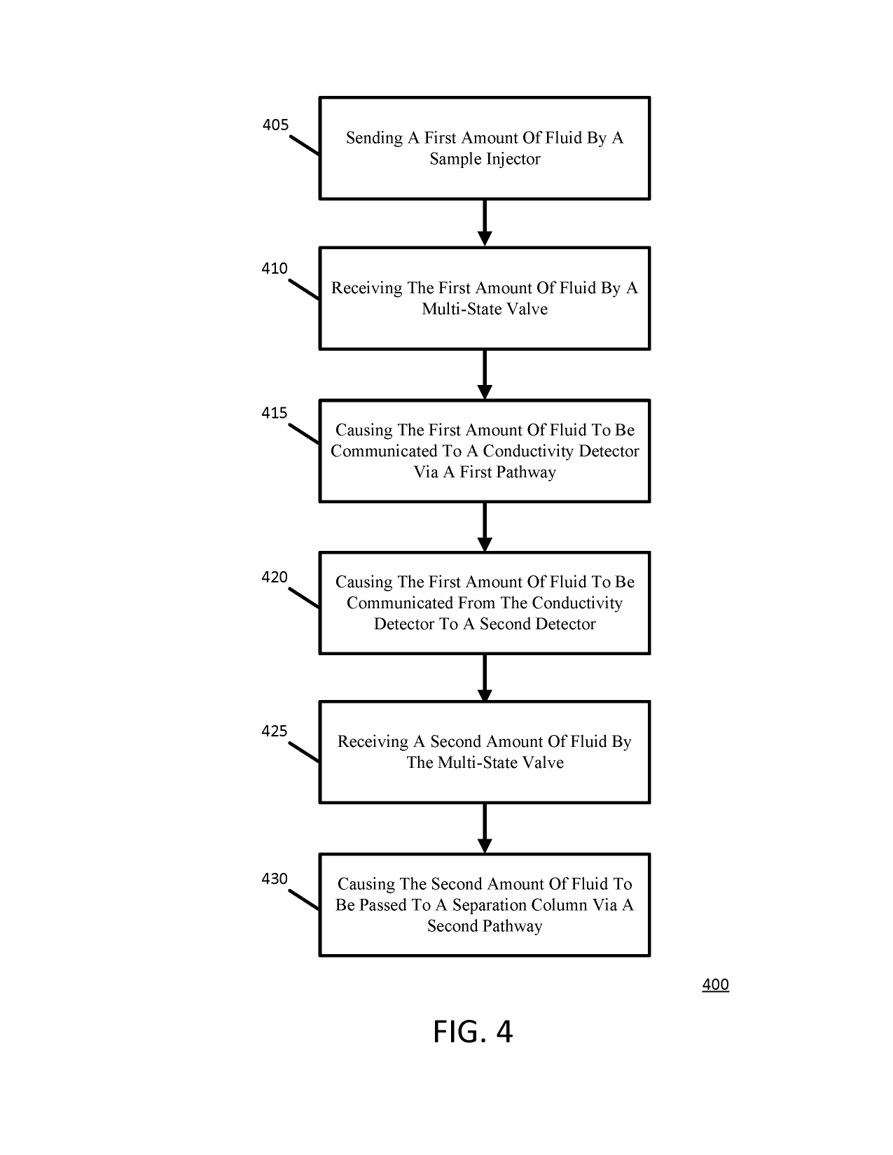

FIG. 4 shows a process 400 according to the present disclosure. The process can be performed by a chromatography system, such as system 100 as described with reference to FIGS. 1-3. At Step 405, a sample injector of the ion chromatography system can send a first amount of fluid. The fluid can include a sample, an eluent, or both. The sample injector can include an autosampler, an eluent generator, or both.

At Step 410, the first amount of fluid can be received by a multi-state valve of the chromatography system. The multi-state valve can be a 6-port valve. The multi-state valve can include a first pathway and a second pathway. The multi-state valve can be transitionable between the first pathway and the second pathway, such that the multi-state valve places the sample injector in fluidic communication with the first pathway, or the second pathway, at any given time.

At Step 415, the first amount of fluid can be communicated to a conductivity detector via the first pathway. The conductivity detector can be an example of detector 140 of FIG. 1. The conductivity detector can measure characteristics of the fluid. For example, the conductivity detector can measure the conductivity of the fluid.

At Step 420, the first amount of fluid can be communicated from the conductivity detector to a second detector via the first pathway. The second detector can be an example of detector 116 of FIG. 1. In some cases, first amount of fluid can pass through a suppressor (e.g., suppressor 114) prior to being received by the second detector. The second detector can take measurements of the first amount of fluid. For example, in some cases the second detector can be a conductivity detector, and the second detector can measure the conductivity of the first amount of fluid. In some cases, based on the measurements taken by the detector(s), the system can determine an abnormality with one or more components of the system. For example, the abnormality can be associated with the sample injector, one of the detectors, the suppressor, or the first amount of fluid.

At Step 425, a second amount of fluid can be received by the multi-port valve. The second amount of fluid can be received from the sample injector. The second amount of fluid can be of a sample, an eluent, or both. The second amount of fluid can be received from an autosampler, an eluent generator, or both.

At Step 430, the second amount of fluid can be passed to a second pathway of the multi-state valve. The second pathway can fluidically couple the sample injector to a separation column. The multi-state valve can transition from the first pathway to the second pathway prior to receiving the second amount of fluid. Thus, the sample injector can not be fluidically coupled to the first pathway when sending the second amount of fluid. The separation column can receive the second amount of fluid via the second pathway, and can send the second amount of fluid to the second detector (e.g., via the second pathway). In some cases, the second amount of fluid can pass through the suppressor prior to passing to the second detector via the second pathway. In some cases, the second detector can measure characteristics of the second amount of fluid (e.g., conductivity measurements).

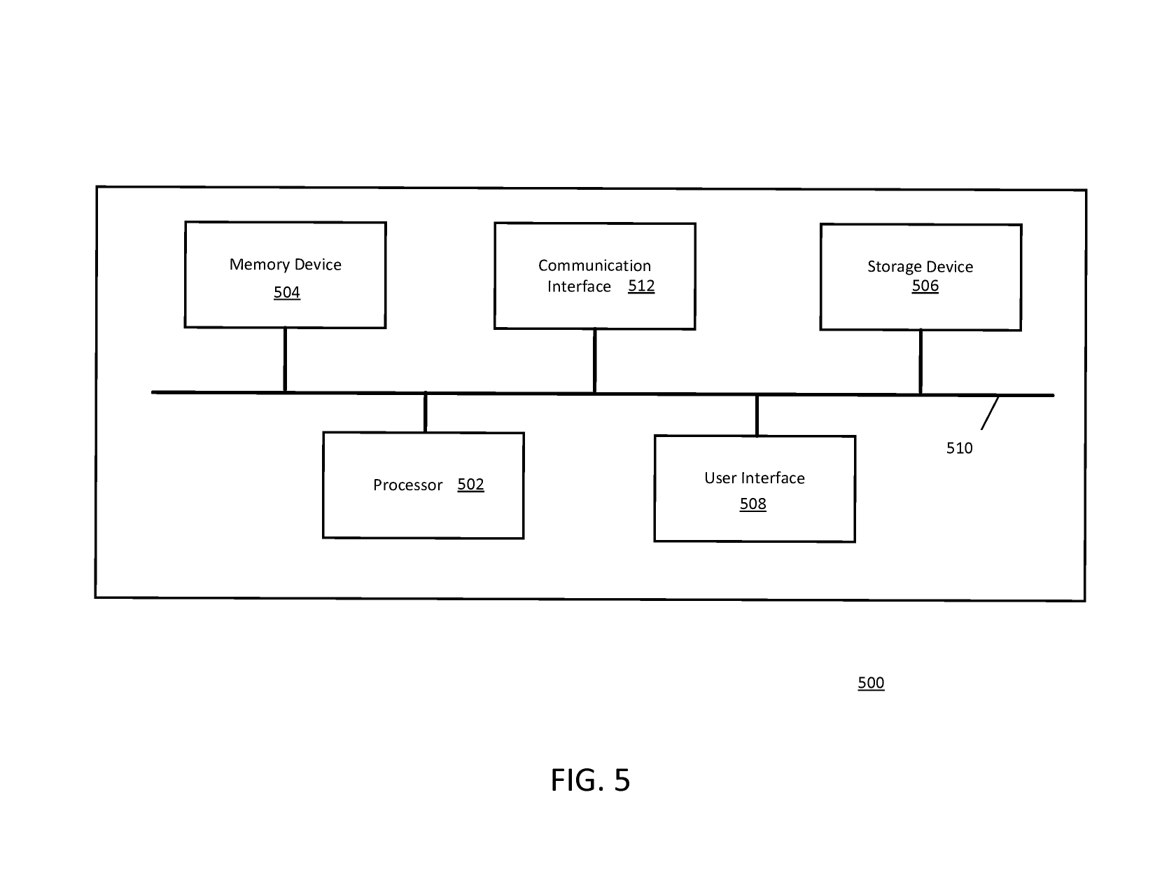

FIG. 5 depicts a controller 500 according to the present disclosure. The controller 1200 can be an example of controller 118 discussed with reference to FIG. 1.

The controller 500 can be a computing device such as a microcontroller, a general purpose computer – which can be, for example, a personal computer or PC – a workstation, a mainframe computer system, and so forth. The controller 500 can include a processor device 502 – which can be, for example, a central processing unit or “CPU”, a memory device 504, a storage device 506, a user interface 508, a system bus 510, and a communication interface 512.

The processor 502 can be any type of processing device for carrying out instructions, processing data, and so forth.

The memory device 504 can be any type of memory device including any one or more of random access memory (“RAM”), read-only memory (“ROM”), Flash memory, Electrically Erasable Programmable Read Only Memory (“EEPROM”), and so forth.

The storage device 506 can be any data storage device for reading/writing from/to any removable and/or integrated optical, magnetic, and/or optical-magneto storage medium, and the like; storage can be, for example, a hard disk, a compact disc-read-only memory “CD-ROM”, CD-ReWritable CDRW,” Digital Versatile Disc-ROM “DVD-ROM”, DVD-RW, and so forth. The storage device 506 can also include a controller/interface for connecting to the system bus 510. Thus, the memory device 504 and the storage device 1206 are suitable for storing data as well as instructions for programmed processes for execution on the processor 502.

The user interface 508 can include a touch screen, control panel, keyboard, keypad, display or any other type of interface, which can be connected to the system bus 510 through a corresponding input/output device interface/adapter.

The communication interface 512 can be adapted and configured to communicate with any type of external device, or with other components of the gas control device. The communication interface 512 can further be adapted and configured to communicate with any system or network, such as one or more computing devices on a local area network (“LAN”), wide area network (“WAN”), the Internet, and so forth. The communication interface 512 can be connected directly to the system bus 510 or can be connected through a suitable interface.

The controller 500 can, thus, provide for executing processes, by itself and/or in cooperation with one or more additional devices, that can include algorithms for controlling components of the sample interrogation system in accordance with the present disclosure. The controller 500 can be programmed or instructed to perform these processes according to any communication protocol and/or programming language on any platform. Thus, the processes can be embodied in data as well as instructions stored in the memory device 504 and/or storage device 506, or received at the user interface 508 and/or communication interface 512 for execution on the processor 502.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

An ion chromatography system, comprising: a sample injector; a multi-state valve in fluidic communication with the sample injector, the multi-state valve being transitionable between a first state and a second state; and a detector in fluidic communication with the multi-state valve, wherein: a) the first state of the multi-state valve places the sample injector and the detector in fluidic communication with a conductivity detector, and b) the second state of the multi-state valve places the sample injector and the detector in fluidic communication with a separation column.

### Embodiment 2

The ion chromatography system of Embodiment 1, further comprising a suppressor in fluidic communication with the detector, and the ion chromatography system being configured such that (1) the suppressor is in fluidic communication with the sample injector when the multi-state valve is in the first state and (2) the suppressor is in fluidic communication with the sample injector when the multi-state valve is in the second state.

### Embodiment 3

The ion chromatography system of any of Embodiments 1 to 2, wherein the multi-state valve comprises a 6-port valve.

### Embodiment 4

The ion chromatography system of any of Embodiments 1 to 3, further comprising a controller configured to cause the multi-state valve to transition between one of the first state and the second state and the other of the first state and the second state.

### Embodiment 5

The ion chromatography system of any of Embodiments 1 to 4, wherein the sample injector comprises: an auto sampler; a sample loop; and a multiport valve in fluidic communication with the sample loop and the multi-state valve.

### Embodiment 6

The ion chromatography system of any of Embodiments 1 to 5, further comprising an eluent generator in fluidic communication with the multi-state valve.

### Embodiment 7

The ion chromatography system of any of Embodiments 1 to 6, wherein the multi-state valve is configured to: permit passing of a sample, an eluent, or both, through the conductivity detector and to the detector when in the first state; and permit passing of a sample, an eluent, or both through the separation column and to the detector when in the second state.

### Embodiment 8

A method comprising: sending, by a sample injector of an ion chromatography system, a first amount of fluid; receiving, by a multi-state valve in fluidic communication with the sample injector, the first amount of fluid; and causing: a) the first amount of fluid to be communicated to a conductivity detector of the ion chromatography system, via a first fluidic pathway of a plurality of fluidic pathways of the multi-state valve; and b) the first amount of fluid to be communicated from the conductivity detector to a second detector of the ion chromatography system via the first fluidic pathway.

### Embodiment 9

The method of Embodiment 8, further comprising: measuring one or more characteristics of the first amount of fluid by the conductivity detector; and determining, based on the measuring, whether an abnormal operating condition exists for the ion chromatography system.

### Embodiment 10

The method of any of Embodiments 8 to 9, wherein the abnormal operating condition comprises any one or more of an abnormal flow rate for an eluent generator, an abnormal concentration for the first amount of fluid, or an abnormal flow rate for the sample injector.

### Embodiment 11

The method of any of Embodiments 8 to 10, further comprising: measuring another one or more characteristics of the first amount of fluid by the second detector, wherein the determining is further based on the measuring the other one or more characteristics.

### Embodiment 12

The method of any of Embodiments 8 to 11, wherein the abnormal operating condition comprises an abnormal functioning of a suppressor in fluidic communication with the conductivity detector and the second detector.

### Embodiment 13

The method of any of Embodiments 8 to 12, further comprising: sending a second amount of fluid by the sample injection; receiving, by the multi-state valve, the second amount of fluid; and causing: a) the second amount of fluid to be passed to a separation column of the ion chromatography system, via a second pathway of a plurality of pathways of the multi-state valve; and b)the second amount of fluid to be passed from the separation column to the second detector via the second pathway.

### Embodiment 14

The method of any of Embodiments 8 to 13, wherein the second amount of fluid does not pass through the conductivity detector, the fluid does not pass through the separation column, or both.

### Embodiment 15

A non-transitory, computer-readable medium comprising a set of computer-executable instructions that, when executed by one or more processors, cause: sending a first amount of fluid from a sample injector of an ion chromatography system to a multi-state valve of the ion chromatography system; sending a second amount of fluid from the sample injector to the multi-state valve; and causing: the first amount of fluid to pass to a conductivity detector of the ion chromatography system via a first fluidic pathway of the multi-state valve; and the second amount of fluid to pass to a separation column of the ion chromatography system via second fluidic pathway of the multi-state valve.

### Embodiment 16

The non-transitory, computer-readable medium of Embodiment 15, wherein the set of computer-executable instructions, when executed by the one or more processors, further cause the multi-state valve to transition between the first fluidic pathway to the second pathway prior to the sending of the second amount of fluid.

### Embodiment 17

The non-transitory, computer-readable medium of any of Embodiments 15 to 16, wherein the set of computer-executable instructions, when executed by the one or more processors, further cause: measuring, by the conductivity detector, one or more characteristics of the first amount of fluid; and determining, based on the one or more characteristics, whether an abnormal operating condition exists for the ion chromatography system.

### Embodiment 18

The non-transitory, computer-readable medium of any of Embodiments 15 to 17, wherein the set of computer-executable instructions, when executed by the one or more processors, further cause: determining an abnormal condition does not exist based on the one or more characteristics of the first amount of fluid; and transitioning the multi-state valve to the second pathway for the second fluid based on the determining an abnormal condition does not exist.

### Embodiment 19

The non-transitory, computer-readable medium of any of Embodiments 15 to 18, wherein the set of computer-executable instructions, when executed by the one or more processors, further cause: passing the first amount of fluid from the conductivity detector to a second detector of the ion chromatography system via the first fluidic pathway; and passing the second amount of fluid from the separation column to the second detector via the second fluidic pathway.

### Embodiment 20

The non-transitory, computer-readable medium of any of Embodiments 15 to 19, wherein the first amount of fluid comprises an eluent, and the second amount of fluid comprises a sample.

What is claimed:

1. An ion chromatography system, comprising:
a sample injector;
a multi-state valve in fluidic communication with the sample injector, the multi-state valve being transitionable between a first state and a second state; and
a detector in fluidic communication with the multi-state valve, wherein:
a) the first state of the multi-state valve places the sample injector and the detector in fluidic communication with a conductivity detector, andb) the second state of the multi-state valve places the sample injector and the detector in fluidic communication with a separation column.

2. The ion chromatography system of claim 1, further comprising a suppressor in fluidic communication with the detector, and the ion chromatography system being configured such that (1) the suppressor is in fluidic communication with the sample injector when the multi-state valve is in the first state and (2) the suppressor is in fluidic communication with the sample injector when the multi-state valve is in the second state.

3. The ion chromatography system of claim 1, wherein the multi-state valve comprises a 6-port valve.

4. The ion chromatography system of claim 1, further comprising a controller configured to cause the multi-state valve to transition between one of the first state and the second state and the other of the first state and the second state.

5. The ion chromatography system of claim 1, wherein the sample injector comprises:
an auto sampler;
a sample loop; and
a multiport valve in fluidic communication with the sample loop and the multi-state valve.

6. The ion chromatography system of claim 5, further comprising an eluent generator in fluidic communication with the multi-state valve.

7. The ion chromatography system of claim 1, wherein the multi-state valve is configured to:
permit passing of a sample, an eluent, or both, through the conductivity detector and to the detector when in the first state; and
permit passing of a sample, an eluent, or both through the separation column and to the detector when in the second state.

8. A method comprising:
sending, by a sample injector of an ion chromatography system, a first amount of fluid;
receiving, by a multi-state valve in fluidic communication with the sample injector, the first amount of fluid; and
causing:
a) the first amount of fluid to be communicated to a conductivity detector of the ion chromatography system, via a first fluidic pathway of a plurality of fluidic pathways of the multi-state valve; and
b) the first amount of fluid to be communicated from the conductivity detector to a second detector of the ion chromatography system via the first fluidic pathway.

9. The method of claim 8, further comprising:
measuring one or more characteristics of the first amount of fluid by the conductivity detector; and
determining, based on the measuring, whether an abnormal operating condition exists for the ion chromatography system.

10. The method of claim 9, wherein the abnormal operating condition comprises any one or more of an abnormal flow rate for an eluent generator, an abnormal concentration for the first amount of fluid, or an abnormal flow rate for the sample injector.

11. The method of claim 9, further comprising:
measuring another one or more characteristics of the first amount of fluid by the second detector, wherein the determining is further based on the measuring the other one or more characteristics.

12. The method of claim 11, wherein the abnormal operating condition comprises an abnormal functioning of a suppressor in fluidic communication with the conductivity detector and the second detector.

13. The method of claim 8, further comprising:
sending a second amount of fluid by the sample injector;
receiving, by the multi-state valve, the second amount of fluid; and
causing:
a) the second amount of fluid to be passed to a separation column of the ion chromatography system, via a second pathway of a plurality of pathways of the multi-state valve; andb) the second amount of fluid to be passed from the separation column to the second detector via the second pathway.

14. The method of claim 13, wherein the second amount of fluid does not pass through the conductivity detector, the fluid does not pass through the separation column, or both.

15. A non-transitory, computer-readable medium comprising a set of computer-executable instructions that, when executed by one or more processors, cause:
sending a first amount of fluid from a sample injector of an ion chromatography system to a multi-state valve of the ion chromatography system;
sending a second amount of fluid from the sample injector to the multi-state valve; and
causing:
the first amount of fluid to pass to a conductivity detector of the ion chromatography system via a first fluidic pathway of the multi-state valve; and
the second amount of fluid to pass to a separation column of the ion chromatography system via second fluidic pathway of the multi-state valve.

16. The non-transitory, computer-readable medium of claim 15, wherein the set of computer-executable instructions, when executed by the one or more processors, further cause the multi-state valve to transition between the first fluidic pathway to the second fluidic pathway prior to the sending of the second amount of fluid.

17. The non-transitory, computer-readable medium of claim 15, wherein the set of computer-executable instructions, when executed by the one or more processors, further cause:
measuring, by the conductivity detector, one or more characteristics of the first amount of fluid; and
determining, based on the one or more characteristics, whether an abnormal operating condition exists for the ion chromatography system.

18. The non-transitory, computer-readable medium of claim 17, wherein the set of computer-executable instructions, when executed by the one or more processors, further cause:
determining an abnormal condition does not exist based on the one or more characteristics of the first amount of fluid; and
transitioning the multi-state valve to the second fluidic pathway for the second amount of fluid based on the determining an abnormal condition does not exist.

19. The non-transitory, computer-readable medium of claim 15, wherein the set of computer-executable instructions, when executed by the one or more processors, further cause:
passing the first amount of fluid from the conductivity detector to a second detector of the ion chromatography system via the first fluidic pathway; and
passing the second amount of fluid from the separation column to the second detector via the second fluidic pathway.

20. The non-transitory, computer-readable medium of claim 15, wherein the first amount of fluid comprises an eluent, and the second amount of fluid comprises a sample.
